(19) United States
(12) Patent Application Publication
(10) Pub. No.: US 2017/0098206 A1
(43) Pub. Date: Apr. 6, 2017

(54) TRANSACTIONAL USER INTERFACE

(71) Applicant: Microsoft Technology Licensing, LLC, Redmond, WA (US)

(72) Inventors: Jeffrey Blucher, Seattle, WA (US); Balaji Balasubramanian, Seattle, WA (US); Raghunath Mallya, Redmond, WA (US); Kollen Glynn, Newcastle, WA (US); Ashvin Mathew, Kirkland, WA (US); Zachary Linster, Seattle, WA (US); Yabin Liu, Kirkland, WA (US)

(21) Appl. No.: 14/874,142

(22) Filed: Oct. 2, 2015

(51) Int. Cl. G06Q 20/20; G06F 3/0488; G06F 3/0484

(52) U.S. Cl. CPC G06Q 20/202; G06F 3/04847; G06F 3/0488

(57) ABSTRACT

A computer system for supporting a plurality of locations that each generate sales transactions is provided. The computer system includes a processor and a user interface component coupled to the processor. A configuration component is coupled to the user interface component and is configured to allow a user to configure at least one aspect of a user interface that is provided on a point of sale device with respect to at least one location and to store the configuration information.

### BACKGROUND

Point-of-sale (POS) terminals and devices occupy a particularly important nexus between the complexities of modern commerce and the exigencies of customer service. On one hand, a given retail enterprise may offer hundreds of thousands of distinct products or services. Additionally, at any given time, any number of various promotions may be operative for any or all of the products and services. Further still, each individual customer may have a certain loyalty or incentive points that may be applicable to any or all such goods and services. Thus, it can be appreciated that the various permutations of promotions/products/customers presents a formidable challenge for retail enterprises to deal with effectively. However, the retail enterprise is not generally provided with significant time in order to address all such issues. Instead, modern experience has taught customers that once they are prepared to checkout or otherwise purchase their products and services, the amount of time from presenting their goods and services to the point-of-sale user (for example, a cashier) to the time when payment is completed, is on the order of a few minutes. Beyond that, the customer may become impatient and/or agitated for fear slowing down the system for the following customers in line.

Providing an improved point-of-sale user interface that allows users to more effectively navigate the vast permutations of various goods, promotions, operations, and transactions will improve not only the experience of the point-of-sale users, but that of the customers of the retail enterprise as well.

The discussion above is merely provided for general background information and is not intended to be used as an aid in determining the scope of the claimed subject matter.

### SUMMARY

A computer system for supporting a plurality of locations that each generate sales transactions is provided. The computer system includes a processor and a user interface component coupled to the processor. A configuration component is coupled to the user interface component and is configured to allow a user to configure at least one aspect of a user interface that is provided on a point of sale device with respect to at least one location and to store the configuration information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of one example of a topology in which embodiments described herein are particularly useful.

FIG. 2 is a diagrammatic view of a retail server system in accordance with one embodiment.

FIG. 3 is a diagrammatic view of a headquarters application in accordance with one embodiment.

FIG. 4 is a diagrammatic view of a point of sale device in accordance with one embodiment.

FIGS. 5A and 5B are a flow diagram and diagrammatic user interface, respectively, of a user login in accordance with one embodiment.

FIG. 6 is a diagrammatic view of a mobile point of sale device in accordance with one embodiment.

FIG. 7 is a diagrammatic view of an on demand vertical navigation bar deployed in a user interface of a point of sale device in accordance with one embodiment.

FIG. 8 is a diagrammatic view of a portion of a user interface of a point of sale terminal that is displayed when a user selects or otherwise presses home screen button, in accordance with one embodiment.

FIG. 9 is a diagrammatic view of a portion of a user interface of a point of sale device in accordance with one embodiment.

FIG. 10 is a diagrammatic view of a portion of a user interface of a point of sale device in accordance with another embodiment.

FIGS. 11A-11C illustrate the application of one or more product refiners in accordance with one embodiment.

FIG. 12 is a diagrammatic view of a portion of a user interface of a point of sale device in accordance with one embodiment.

FIG. 13 is a flow diagram of a method of supporting a transaction using a point of sale device in accordance with embodiments described herein.

FIG. 14 is a diagrammatic view of a portion of a user interface of a point of sale device in accordance with one embodiment.

FIG. 15 is a diagrammatic view of a user interface of a point of sale device where the user has selected home button, in accordance with one embodiment.

FIG. 16 is a diagrammatic view of a user interface of a point of sale device providing a transaction-centric display, in accordance with one embodiment.

FIG. 17 is a block diagram of an architecture, shown in FIG. 3, except that some elements are disposed in a cloud computing architecture.

FIGS. 18-20 are diagrammatic views of mobile devices that can be used as point of sale devices in accordance with embodiments described herein.

FIG. 21 is a diagrammatic view of a computing system that can be deployed in accordance with embodiments described herein.

### DETAILED DESCRIPTION

With various point of sale users sharing any one point of sale application or device, the vast range of operations, workflows, and user preferences necessitates flexibility. Further, strict business rules govern many operations as well as which users may invoke them. Accordingly, retailers need a way to restrict access to certain operations without having to create custom interfaces for each individual employee. Further still, business processes dictate the requirements for daily activities, whether those activities are task operations or transactions, and point of sale users require a system that reduces the “noise” so that they can focus on contextually relevant content.

With retailers spanning the globe, and both assortments and catalogs constantly evolving across an omni-channel landscape, such retailers require central management of their merchandizing execution so that point of sale users (e.g. cashiers) in any given store can have access to an accurate reflection of the current categories and their products. In accordance with embodiments described herein, an improved user interface of a point of sale system can streamline the delivery of custom content across channels, devices, and platforms through the metadata generated by a centrally-controlled rules engine. This is all done while still reducing maintenance cost due to centralized location of the tools needed to publish such updates.

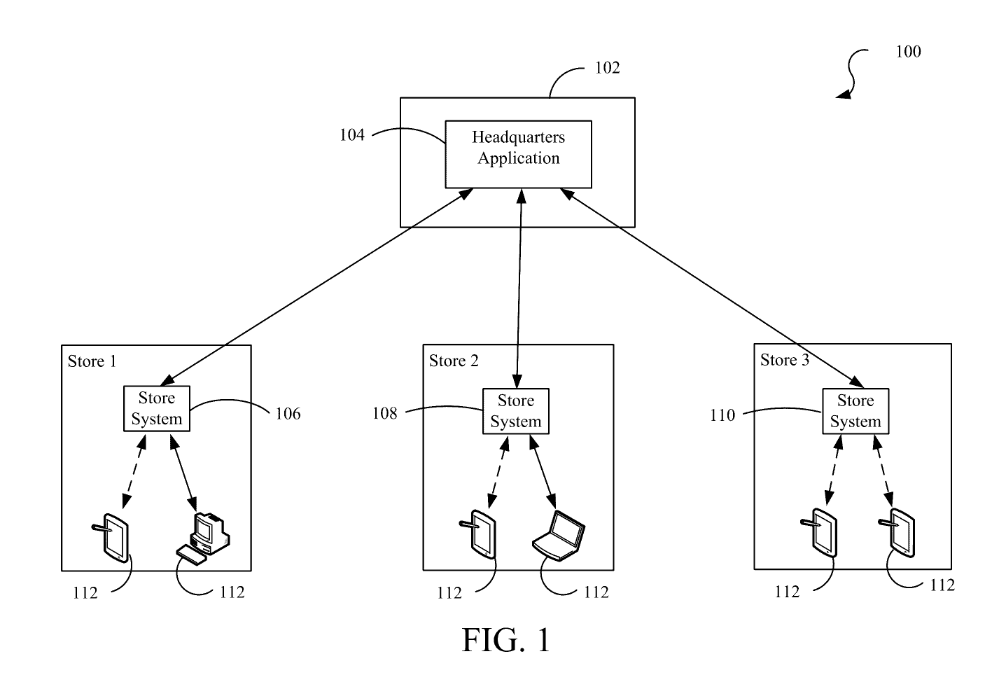

FIG. 1 is a diagrammatic view of one example of a topology in which embodiments described herein are particularly useful. As shown, retail enterprise 100 includes a headquarters 102 that has deployed a headquarters application 104. The headquarters 102 will interact with various stores (stores 1-3 are shown in FIG. 1) by interacting with each respective store's store system 106, 108, and 110. Further still, each store may have any suitable number of point of sale devices that are used by users (employees of the retail enterprise) in order to assist customers. While point of sale devices have traditionally been fixed systems mounted to cash drawers, modern point of sale systems are not so limited. In fact, point of sale systems, as defined herein, include any suitable electronic devices that are able to execute at least one operation in the furtherance of a customer's retail transaction. Accordingly, such point of sale devices include the traditional cash register system as well as a variety of mobile devices. For example, such point of sale devices include modern tablets, smart phones, notebooks, or other suitable devices now known or later developed that may be useful to employees of the retail enterprise in assisting customers. Further, the various point of sale devices may interact with their respective store systems via wired network communication as shown in FIG. 1 via solid bidirectional lines, or wirelessly, as shown by dashed lines. Further, point of sale devices may also interact with headquarters application 104 directly or via their respective store systems.

By using headquarters application 104, retail enterprise 100 can centrally manage a number of aspects of the retail operation. Such central management can include the generation, modification, or deletion of any suitable rules or permissions necessary with respect to individual employees and/or roles (such as a supervisor, cashier, stock assistant, et cetera). Further, the individual interfaces and layouts can be centrally customized based on individual users or rules. Further still, catalog content as well as categories can be edited or otherwise changed centrally at headquarters application 104 and then propagated to the various store systems through any suitable techniques. While the example shown in FIG. 1 illustrates headquarters application 104 operating within headquarters facility 102, it is expressly contemplated that headquarters application 104 may be deployed remotely from headquarters 102, such as a cloud-based deployment. Further, it is also contemplated that any or all of store systems 106, 108, and 110 could be deployed remotely from their respective store and accessed by point of sale devices 112 via wired or wireless communication, as appropriate.

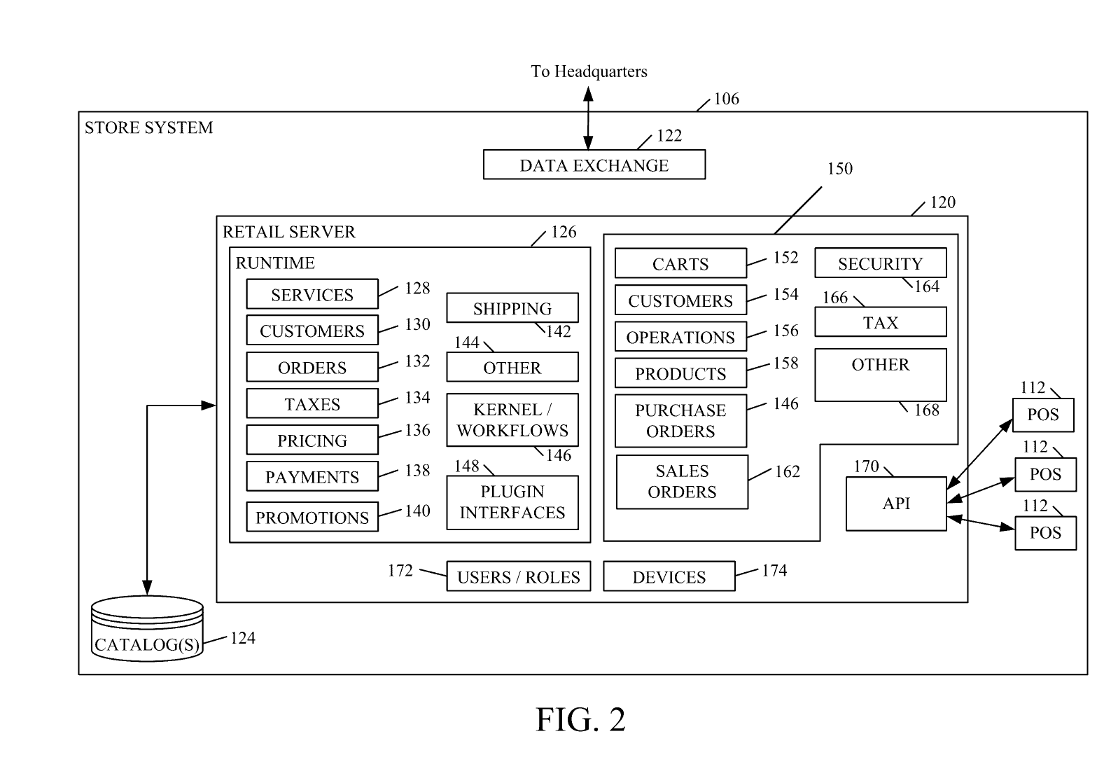

FIG. 2 is a diagrammatic view of a retail server system in accordance with one embodiment. Retail server 120 is one of a number of systems that comprise store system 106. Store system 106 includes a data exchange or a communication component 122 that interacts with headquarters application 104 (shown in FIG. 1). Additionally, store system 106 may also include one or more data stores 124 that include catalog information as well as a channel database. The channel database generally holds retail data for one or more retail channels, such as an online store or brick-and-mortar stores. Retail server 120 interacts with data exchange component 122 and data store 124 in order to provide store functions and operations. Retailer server 120 generally includes a runtime component 126 that is configured to provide and/or support a number of services 128, customer information 130, order information 132, taxes information 134, pricing information 136, payment information 138, promotions information 140, shipping information 142, or any other suitable information 144. Additionally, runtime component 126 also manages information relative to kernel/workflows 146. Finally, runtime component 126 also includes one or more plugin interfaces 148.

Runtime component 126 may invoke or react to events from one or more controllers 150. Examples of controllers 150 include carts controller 152, customers controller 154, operations controller 156, products controller 158, purchase orders controller 160, sales orders controller 162, security controller 164, tax controller 166, and any other suitable controllers 168. Additionally, retail server 120 also includes one or more application programming interfaces 170 that interact with point of sale devices 112.

As shown in FIG. 2, retailer server 120 may also include or otherwise store user/role information 172 and devices information 174. User/role information 172 can include information that indicates what role or roles a particular user has. Further, permissions can be defined relative to particular roles and can be tailored individually for each individual user. All of this information can be stored in user/roles module 172. Additionally, devices information module 174 can include information about each of the point of sale devices 112. Accordingly, if a particular point of sale device has a certain screen size or certain operating system, all such information can be stored within devices information module 174 such that the user interface specification that is provided to the respective point of sale device can be tailored based on the device itself as well as the user who is logged in to the respective device. Accordingly, the point of sale device then merely needs to render the user interface that is tailored substantially for the particular point of sale device and the particular user.

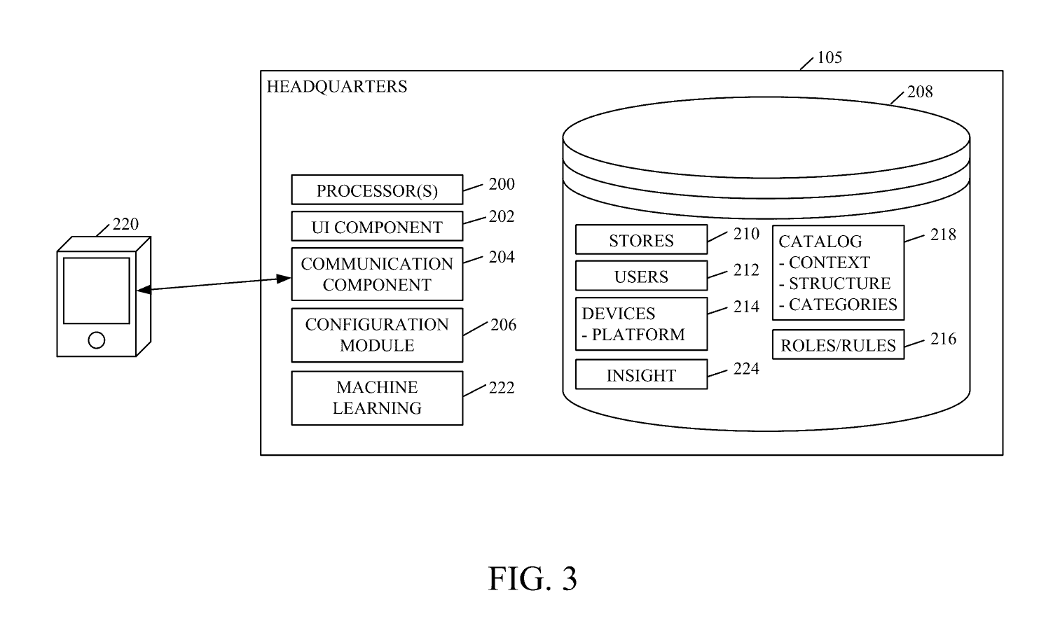

FIG. 3 is a diagrammatic view of headquarters system 105 in accordance with one embodiment. Headquarters system 105 includes one or more processors 200, user interface component 202, communication component 204, and configuration module 206. Additionally, headquarters system 105 may also include data store 208 that contains a centralized repository of data relative to one or more individual stores 210, users 212, devices/platforms 214, roles/rules information 216, and catalog information 218. As can be appreciated, some information stored within headquarters system 105 may be duplicative of information at one or more retail servers, and it is expressly contemplated that synchronization operations may be performed synchronously or asynchronously in order to ensure that such information is properly updated between store systems and headquarters system 105.

Processor(s) 200 can include one or more computer processors or processing components that are able to programmatically execute instructions in order to perform functions for headquarters system 105. Additionally, processor(s) 200, while not shown separately, may include suitable computer readable storage and/or timing circuitry in order to execute such instructions. UI component 202 of headquarters system 105 is configured to interact with user interfaces of user devices, such as user device 220, in order to allow users thereof to manipulate system components, view system reports, or perform any other suitable actions on system 105. Communication component 204 generally includes a network interface or other suitable hardware and/or software that is configured to interact with one or more remote devices, such as user device 220. Finally, configuration module 206 allows a user to configure information relative to the retail operation. Such configuration information, can include the definition of one or more roles within the organization, such as a supervisor or a cashier. Users can then be assigned one or more roles by the retail organization. Configuration module 206 may support the ability to enter information relative to one or more users and/or roles and to specify permissions relative to each. Configuration module 206 also allows the specification of one or more rules relative to the operation. Rules can include the specification of visual profiles for each type of point of sale device, each individual point of sale device, each role, or even each user. Such visual profiles can include information such as colors or themes. Rules information also includes store configuration information. For example, a particular store may have certain business operations enabled, or have its own visual profile based on its location. Further still, rules information can include information that supports the various permissions. This information includes particular business operations or transaction support that an individual user may be allowed to perform or not to perform.

In accordance with an embodiment described herein, headquarters system 105 also includes machine learning component 222. Machine learning component 222 generally receives and analyzes transaction information from one or more of the various stores and/or point of sale devices in order to identify trends or relationships within the transactional data. For example, machine learning component 222 may, through the analysis of a number of transactions, determine that users who buy a new camera also happen to buy a new children's mitt at the same time. Accordingly, machine learning component 222 may automatically be able to surface relative insights to a point of sale user who is assisting a customer purchasing a digital camera in order to potentially suggest the purchase of a children's mitt, or vice versa. Machine learning component 222 can employ any suitable machine learning techniques including the utilization of known neural network technology, in order to generate insight information 224 that may be stored in data store 208. Further, the insight information can also be propagated to one or more relevant stores, as appropriate.

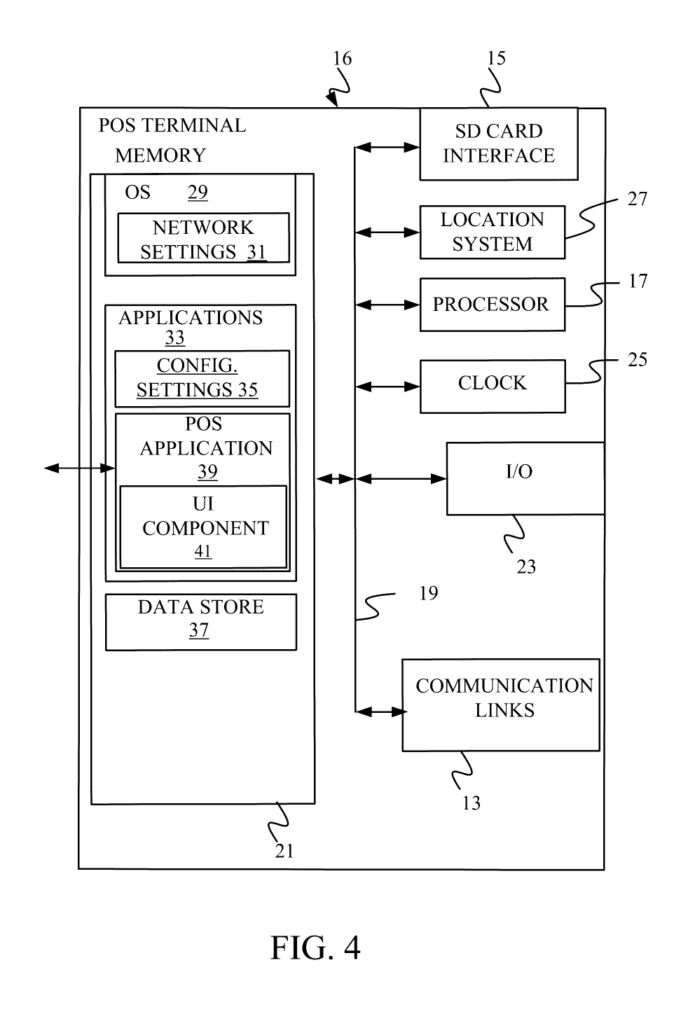

FIG. 4 is a diagrammatic view of components of a mobile point of sale device in accordance with one embodiment. In the device 16, a communications link 13 is provided that allows the mobile device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like POS application 39) are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, barcode scanners, rfid readers, credit card readers, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions.

Examples of the network settings 31 include things such as proxy information, Internet connection information, and mappings. Application configuration settings 35 include settings that tailor the application for a specific enterprise or user.

Applications 33 can be applications that have previously been stored on the device 16 or applications that are installed during use, although these can be part of operating system 29, or hosted external to device 16, as well. In accordance with one embodiment, client applications include a point of sale application 39 that includes a user interface rendering component 41. Once application 39 is invoked, it will initially present a user interface to the user thereof that requires a login. Once the user has successfully logged in, point of sale application 39 will seek out user interface specification information from a suitable retail server, or headquarters server, as appropriate. The user interface specification will be tailored to the particular client device, platform, role, and even user that has logged in. Upon receipt of such user interface specification information, rendering component 41 renders the user interface on a touch-enabled display of the point of sale device.

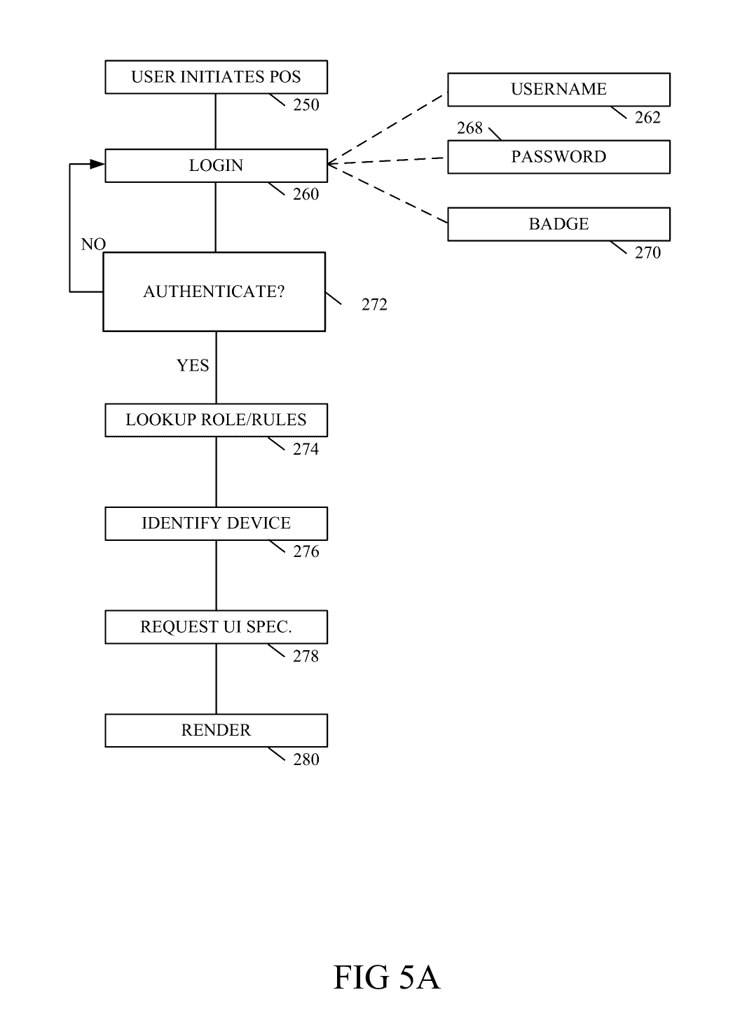

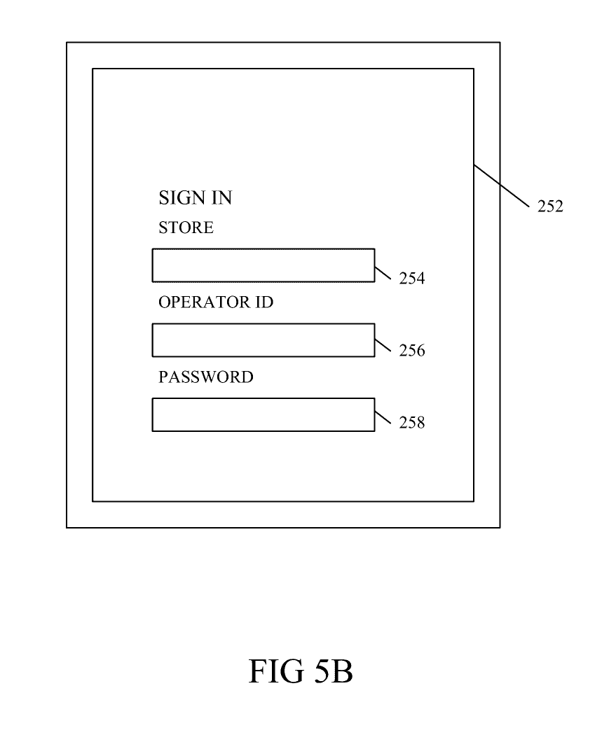

FIGS. 5A and 5B are a flow diagram and diagrammatic user interface of a user login in accordance with one embodiment. As set forth above, a user of a point of sale device first invokes or otherwise starts a point of sale application, such as point of sale application 39. This is indicated at block 250 in FIG. 5A. Once the point of sale application is initiated at block 250, a sign-in screen 252 (shown in FIG. 5B) is presented on the user interface of the point of sale device. Then, a user will select a particular store in store field 254, as well as enter their operator id in field 256. The operator id may be a numeric identifier, or it may be the user's name, or some combination thereof. Finally, the user will enter password information in field 258 and attempt to login as indicated at block 260 in FIG. 5A. While the example shown in FIG. 5B has a user entering a specific store, operator id, and password, it is expressly contemplated that other forms of login are possible. For example, the user may specify a user name 262, password 268, and/or badge 270. Certainly, other information may be required, as appropriate.

Once login process 260 is initiated, the credentials entered by the user are provided to the retail server 120, and particularly to security controller 164, as indicated at block 272. If the authentication is successful, control passes to block 274 where the retail server will perform a lookup of the various role and rules that apply to the particular user who has successfully authenticated the login process. Conversely, if the authentication fails, control returns from block 272 to block 260 and the user is allowed to reattempt login. Returning to the description of block 274, retailer server 120 will identify the role/rules that apply to the user who has successfully authenticated. For example, the role may indicate the authenticated user is a store manager. Further, the rules information may indicate a particular visual profile that the store manager prefers as well as one or more store reports that the user typically runs. Next, at block 276, the device used for the login is identified. This may be generated automatically by the device during the login process or it may be provided by virtue of a device identifier number being looked up in device information 174 of store system 106. Regardless, after blocks 274 and 276 have completed, retailer server 120 will provide a user interface specification in response to the point of sale device's request at block 278. Upon receipt of such user interface specification information, the point of sale device renders the user interface on the display screen of the point of sale device using rendering component 41. As can be appreciated, given the vast array of different devices and operating systems that may be used as point of sale devices, it is important for the rendered user interface to appear effectively on the display screen of the point of sale device and for it to be responsive and intuitive for the user.

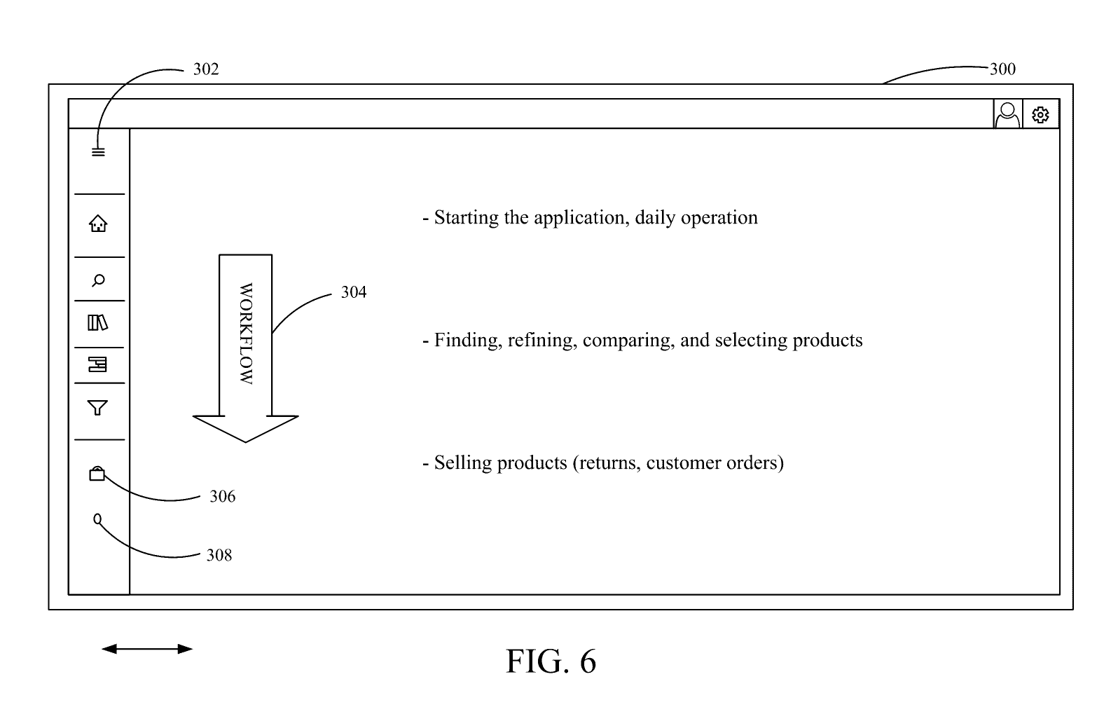

FIG. 6 is a diagrammatic view of a mobile point of sale device in accordance with one embodiment. The mobile device shown in FIG. 6 is a tablet 300, but as set forth above, any suitable device can be used. Since at least some point of sale devices may have relatively small screens, embodiments described herein generally include a dynamically available navigation bar 302 that provides a number of navigation features when activated. In the example shown in FIG. 6, the navigation bar 302 is a vertical bar that appears along the left edge of the display of the point of sale device. However, other locations can be used in accordance with embodiments described herein. Further still, the invocation or call for the navigation bar to display itself can be generated in accordance with any suitable user input. In one example, a user may drag his or her finger rightward from the left edge of the screen thereby causing navigation bar 302 to display itself. However, other user inputs, such as simple button presses, voice commands, or other gestures can be used to cause navigation bar 302 to display itself. Additionally, a similar gesture or user input is typically used in order to cause the navigation bar to hide itself. In the event that such user input is not received within a specified amount of time, navigation bar 302 may also cause itself to hide automatically. The items of navigation bar 302 are, in one example, arranged in the order of the user's workflow 304. For example, items toward the top of navigation bar 302 may be useful for starting the application and performing one or more requisite daily operations. Items near the middle of navigation bar 302 may be useful for identifying products, refining searches for products and/or comparing and selecting products for a particular transaction. Finally, items in navigation bar 302 near the bottom may be useful for facilitating individual transactions, such as selling products, processing customer returns, and configuring shipping details for such transactions. For example, cell 306 of navigation bar 302 has an icon indicative of a shopping cart and an indicator 308 showing the number of items currently in the shopping cart.

Since display size may vary substantially across individual devices and platforms for the point of sale devices, it is expressly contemplated that the entire user interface may be scrollable horizontally, vertically, or both by the user's finger. The horizontal scrolling is particularly useful in that additional tasks and operations can be provided in space that is essentially out of the user's current view. By having such horizontal and/or vertical scrolling of the user interface, additional options and features can be provided with relative ease.

In accordance with embodiments described herein, while the user interface can vary depending on the point of sale device, user role, rules, or other variables, it is preferred that a relatively standardized user interface and navigation bar interaction be provided across all such different user interfaces. This is helpful in that a user who has learned to interact with a point of sale interface, such as a tablet interface, can apply such learning if stationed at a point of sale device that is mounted to a cash register, since both such devices will operate with many of the same gestures and functions. Further, it is expressly contemplated that the user interfaces described herein be deployable on various different types of point of sale devices with various different mobile operating system platforms. Thus, in some embodiments, the point of sale application on the client point of sale device is designed for cross-platform portability.

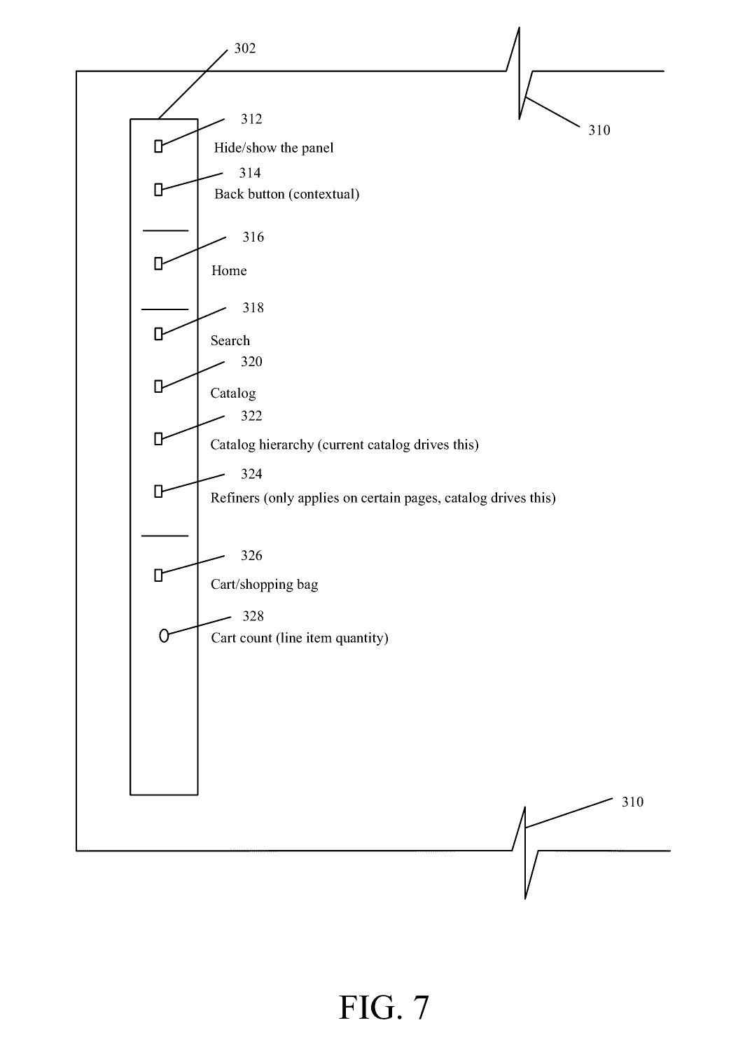

FIG. 7 is a diagrammatic view of an on demand vertical navigation bar deployed on a user interface of a point of sale device in accordance with one embodiment. In the example shown in FIG. 7, only a leftmost portion of the user interface is shown. This is indicated by break lines 310. Vertical navigation bar 302, in the example shown in FIG. 7, has a top most element 312 that provides a toggle that hides or shows the vertical navigation bar 302. Below element 312, is an on-screen back button 314 that returns to a previous operation or screen. As can be appreciated, the previous operation or screen will vary depending on what the user is doing and thus back button 314 is considered a contextual button user interface element. Upon user actuation of back button 314, the point of sale application will determine what the last operation of the user was, and provide navigation to such operation. Below contextual back button 314, home button 316 allows the user to conveniently return to a main or home page. Home button 316 is particularly useful due to the nature of transactions. Accordingly, a point of sale user may generate a number of operations for a particular customer, and once the transaction is complete may need to clear the point of sale device in order to begin entering new transaction information for a new customer. This is simply one example of the context in which home button 316 is particularly useful.

Below home button 316, search button 318, when actuated by the user, will provide a search interface to one or more product catalogs available to the user. The product catalog may be specific to the store or it may be specific to a particular promotion or other suitable subset of products. This searching can include a search interface that receives keywords or SKU numbers in order to identify one or more products in which a customer is interested. Catalog button 320, located below search button 318, allows the point of sale user to view or otherwise manipulate one or more catalogs of the retail operation. Below catalog element 320, catalog hierarchy button 322 may be displayed depending on the current catalog with which the user is interacting. For example, if a particular catalog has a hierarchal structure, then item 322 may become selectable or visible and allow the user to interact with the hierarchal structure itself. Conversely, if the catalog is purely a flat catalog with no hierarchy or other structure, then element 322 may simply not be present. This is an example of a dynamic element on vertical navigation bar 302 that is presented based upon particular context.

Context can include any number of suitable variables or data that are indicative of a particular action that the user is performing. One of the advantages of the provision of one or more such dynamic elements in vertical navigation bar 302 is that vertical navigation bar 302 can respond intelligently to the user's actions and potentially provide more intuitive interaction for the user thereby increasing user efficiency.

Refiners element 324 is another example of a dynamic element in vertical navigation bar 302. This element is only shown and used on certain pages of a particular catalog. Refiners allow a user to specify additional parameters relative to a number of products in order to view a smaller subset. For example, if a large number of digital cameras are provided to a user, one refiner may include a selection of a manufacturer such that a subset containing only that manufacturer's digital cameras is shown to the user. Toward the bottom of vertical navigation bar 302, a cart/shopping bag element 326 allows the user to view a display showing all of the elements present in the user's cart/shopping bag. This facilitates direct interactions with items in the cart, such as changing item quantity, applying promotions or price variations, as may be required. Finally, element 328, at the bottom of vertical navigation bar 302, shows a cart count. This is an indicator of the number of line items in the shopping cart.

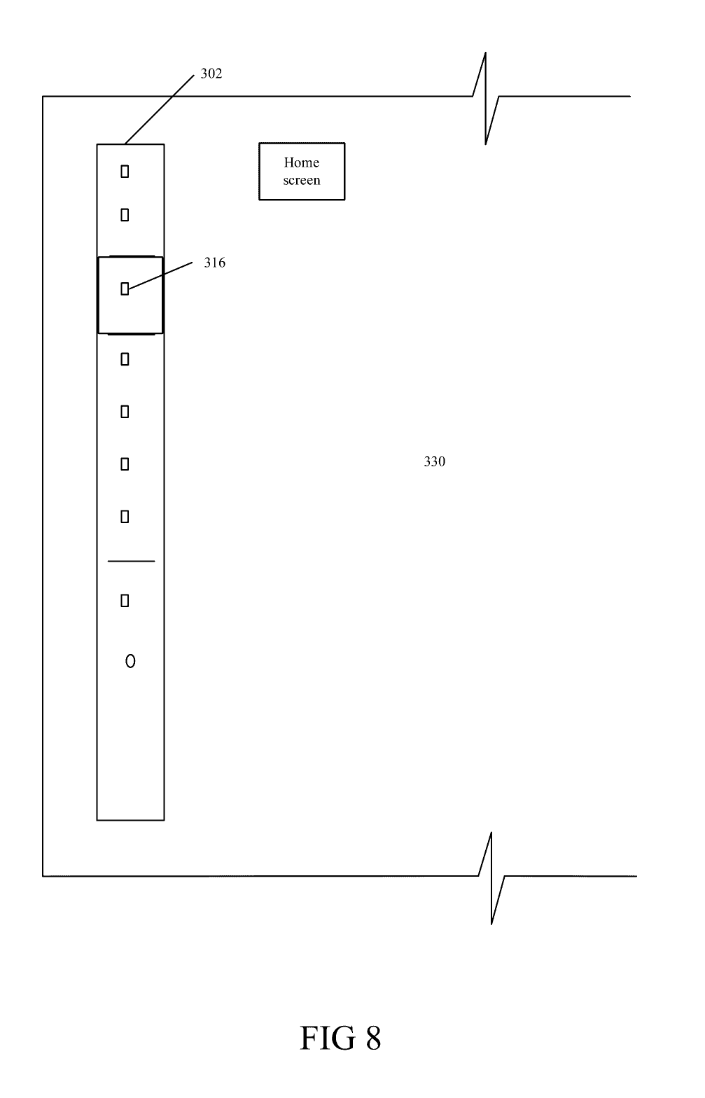

FIG. 8 is a diagrammatic view of a portion of a user interface of a point of sale device that is displayed when a user selects or otherwise presses home screen button 316. When this occurs, the remaining portion 330 to the right of vertical navigation bar 302 will show user interface elements that are appropriate for a home screen for the user. These elements may be provided in the form of one or more tiles, which may be dynamic tiles, as well as messages from the retail operation for the user. Finally, such home screen information may include information that summarizes one or more current promotions so that the user can educate customers about current promotions. As can be appreciated, any suitable information can be selected for display at the home screen. Further still, the identification of one or more user interface elements as displayable on the home screen can be configured centrally using configuration module 206 (shown in FIG. 3).

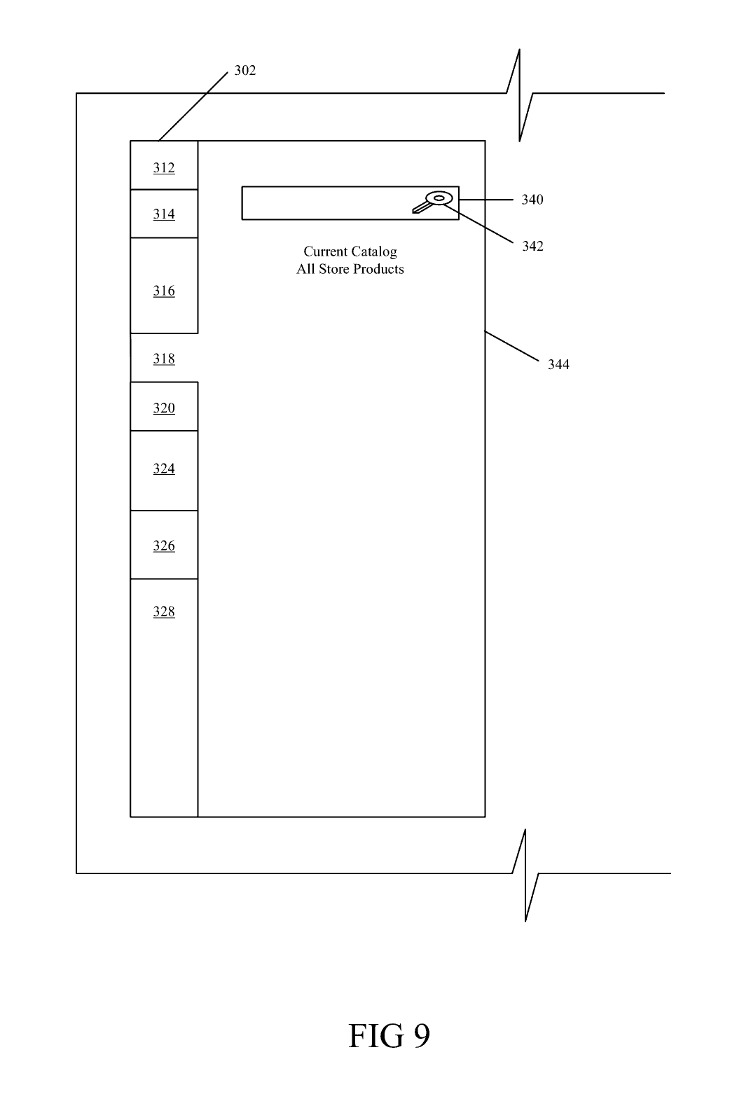

FIG. 9 is a diagrammatic view of a portion of a user interface of a point of sale device in accordance with one embodiment. Specifically, as shown in FIG. 9, a user of the point of sale device has actuated user interface element 318 on vertical navigation bar 302 to perform a searching operation. In response to the actuation of element 318, search box 340 is provided and receives user input relative to the requested search. Once the user has entered the search input into search box 340, the user may select element 342 in order to initiate the search. Additionally, as shown in FIG. 9, search pane 344 indicates an indication of the current catalog upon which the search is executed as well as an indication that the search is currently being executed across all store products in the current catalog. The user is able to click on or otherwise select either of these indications in order to change the current catalog or select a subset of store products or products that are available in one or more stores (such as in the general vicinity of the current store).

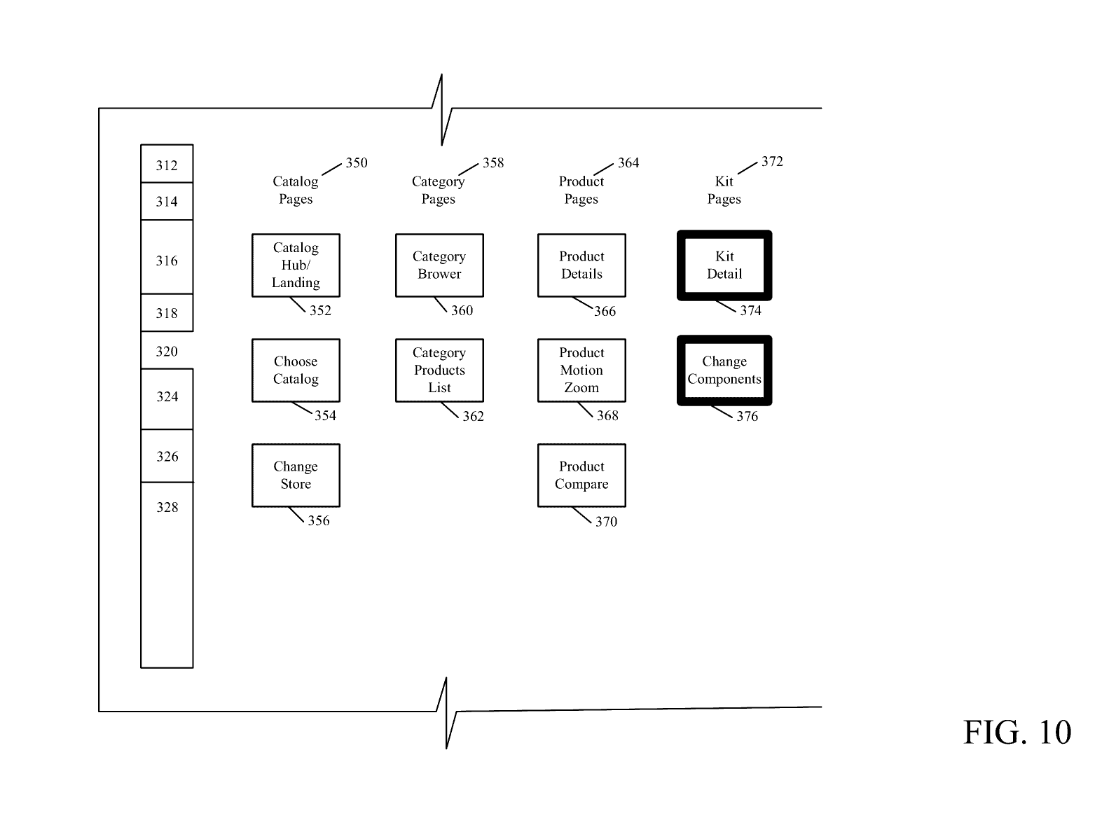

FIG. 10 is a diagrammatic view of a portion of a user interface of a point of sale device in accordance with another embodiment. In the example shown in FIG. 10, a user of the point of sale device has selected user interface element 320 in vertical navigation bar 302. In response to the user actuation of element 320, catalog information is provided on the display of the point of sale device. In particular, the example shown in FIG. 10 provides a number of columns. For example, the leftmost column indicates catalog pages 350, with the category pages column 358 located to the right of the catalog pages column. To the right of the category pages column 358, a product pages column 364 is also provided. Finally, on the right side of the product pages column 364, a kits pages column 372 is provided. In this way, content of increasing specificity is provided generally to the right. In each column, a number of operations are available with respect to the individual column. For example, catalog pages column 350 includes catalog hub/landing tile 352 which, upon selection, will bring the user to a hub or landing page with respect to the currently selected catalog. Additionally, the user may change the currently selected catalog by actuating element 354 and selecting any other suitable catalog. Further, the products displayed within the catalog can be limited to those available in a specific store (such as the current store) by specifying the store after actuating element 356. Within category pages column 358, a user may simply wish to browse a selected category, by actuating tile 360. Additionally, a user may view a product list for a selected category by actuating tile 362. With respect to product pages column 364, a user may select tile 366 in order to view product details with respect to a particular product. Further, a user may also perform a media zoom operation on the selected product by pressing or otherwise actuating tile 368. Finally, a user may compare the selected product to one or more different products by selecting tile 370. Kit pages column 372 allows the user to interact with kits that are available to the customer. In particular, the user may actuate kit detail element 374 in order to view details with respect to a particular kit. As set forth herein, a kit includes two or more products provided by the retailer that work together to provide an overall function or comprise a single unitary device. Below kit detail element 374, element 376 allows the user to change one or more components of the selected kit.

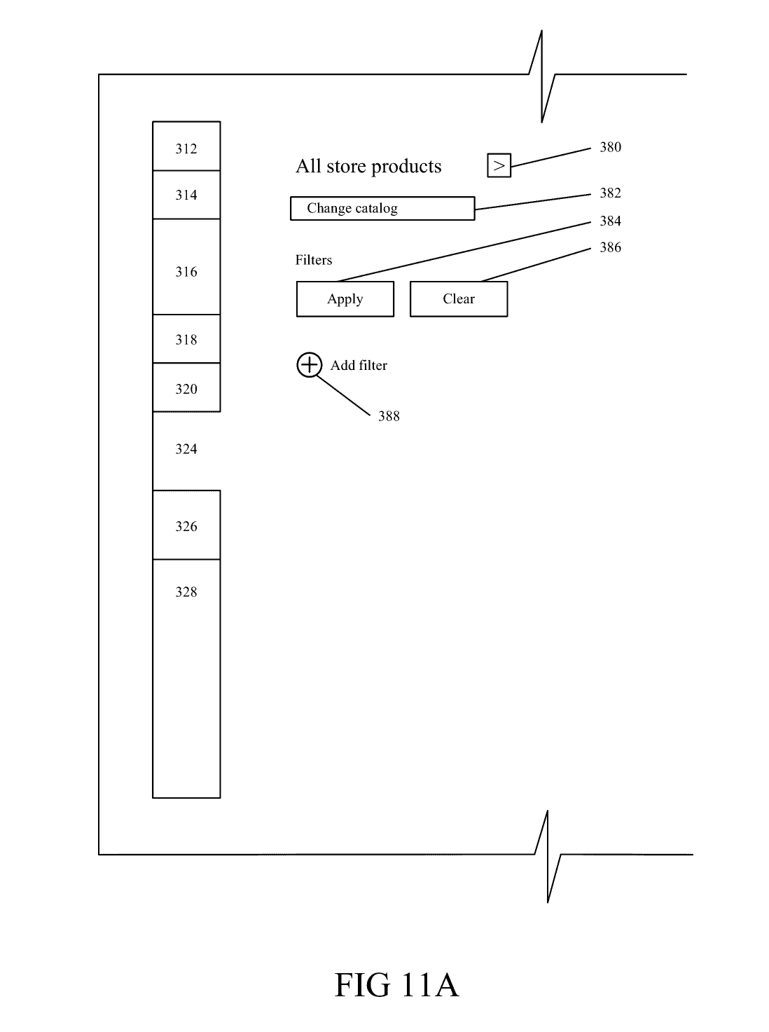

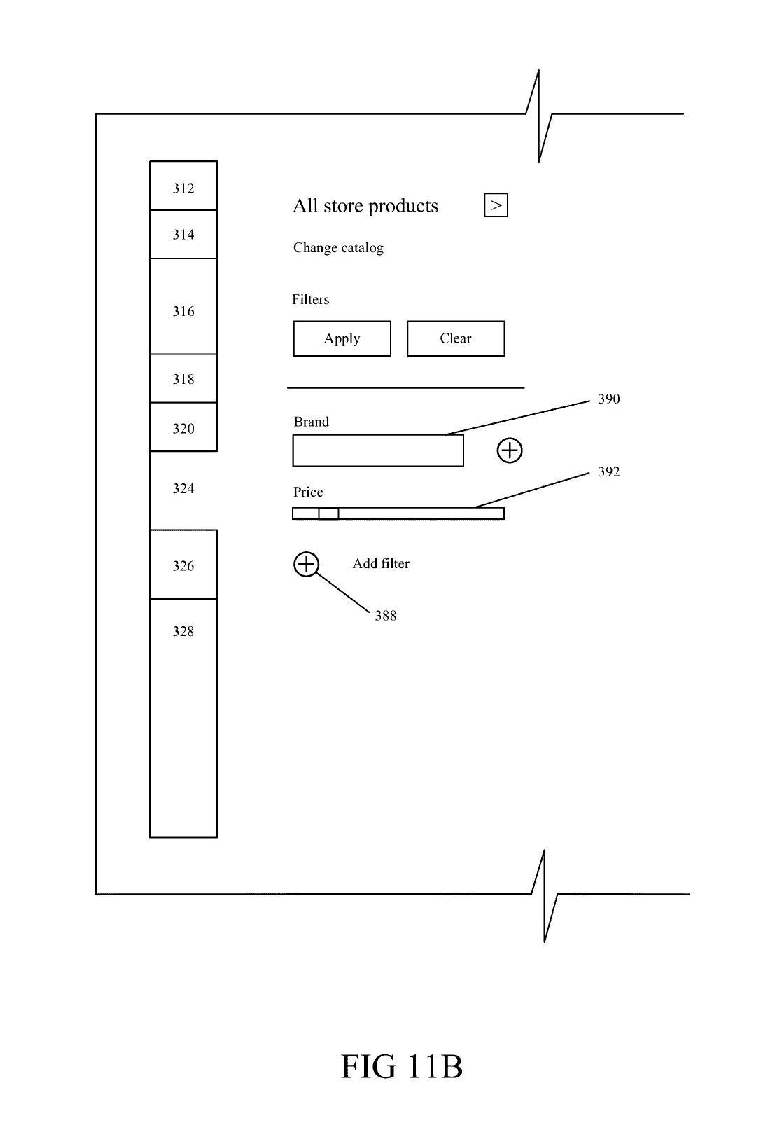

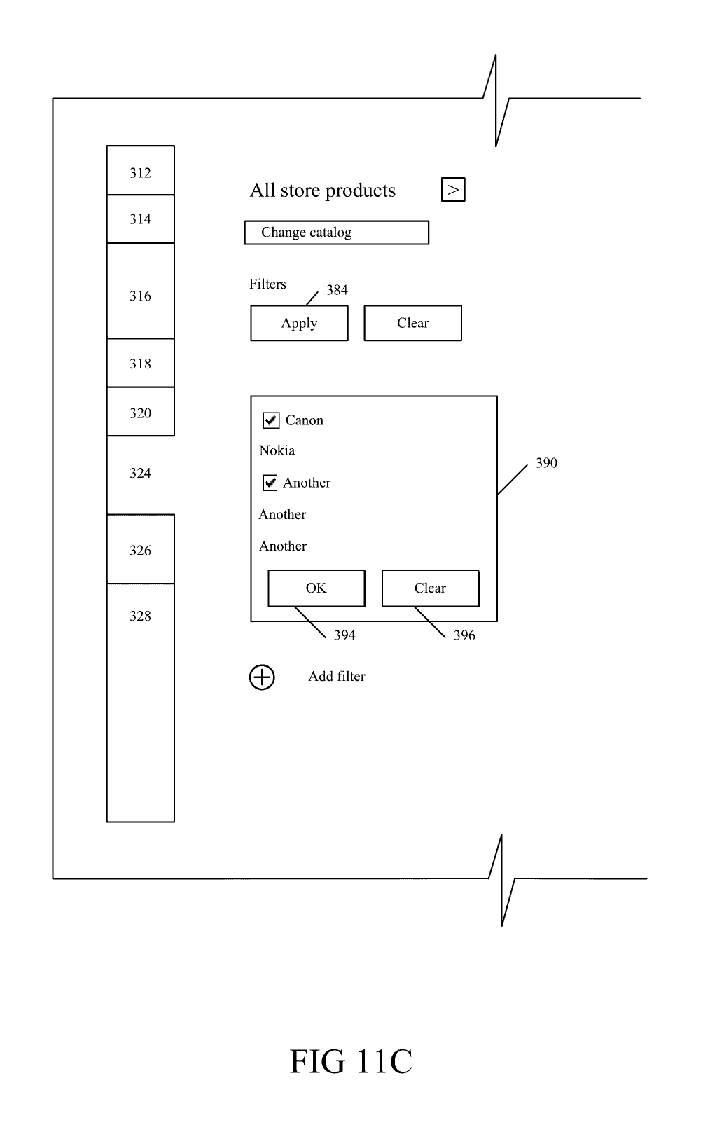

FIGS. 11A-11C illustrate the application of one or more product refiners in accordance with one embodiment. As shown in FIG. 11A, a user of the point of sale device has selected user interface element 324 in order to engage a refiner. As set forth above, the display or provision of refiner element 324 is dynamic and based upon the current context of the system. Accordingly, if the user is not interacting with certain pages of a catalog that require one or more refiners then refiner element 324 is simply not shown. This is one example of a dynamically surfaceable element in vertical navigation bar 302 in accordance with embodiments described herein. For example, if the number of products in the current catalog or category over which the user is searching results in a large number of search results (such as a number above a selected threshold) refiner element 324 can be provided to allow the user to quickly refine or otherwise limit the search results and page displays. As shown in FIG. 11A, the user interface initially indicates the current catalog is directed to all store products and has a user interface element 380 that allows that parameter to be changed. Additionally, user interface element 382, when actuated by the user, allows the current catalog to be changed. Additionally, a pair of elements 384, 386 are provided to allow the user to apply or clear the current filters, respectively. Additionally, as shown in FIG. 11A, user interface element 388 is provided that allows the user to add a filter. When element 388 is actuated by the user, the display changes to that illustrated with respect to FIG. 11B. In particular, the example shown in FIG. 11B shows a pair of selectors in order to refine the product display information. In particular, a brand field 390 is provided that allows the user to select one or more brands of products in which the user is interested. Additionally, a price selector 392 is also provided so that the price of the item can be used in order to refine the product display. Additionally, add filter element 388 is still present in the display in FIG. 11B to allow the user to add still further refiners, as appropriate. In FIG. 11C, the user has selected a pair of brands in brand selector field 390, and has the option to select or otherwise engage element 394 in order to proceed with the brand selection. Conversely, the user may select element 396 in brand selector field 390 in order to clear all current brand selections. Once the user has provided one or more suitable filters, the filters can be applied to the product display information by engaging element 384. This helps the user of the point of sale device quickly find one or more products for the customer.

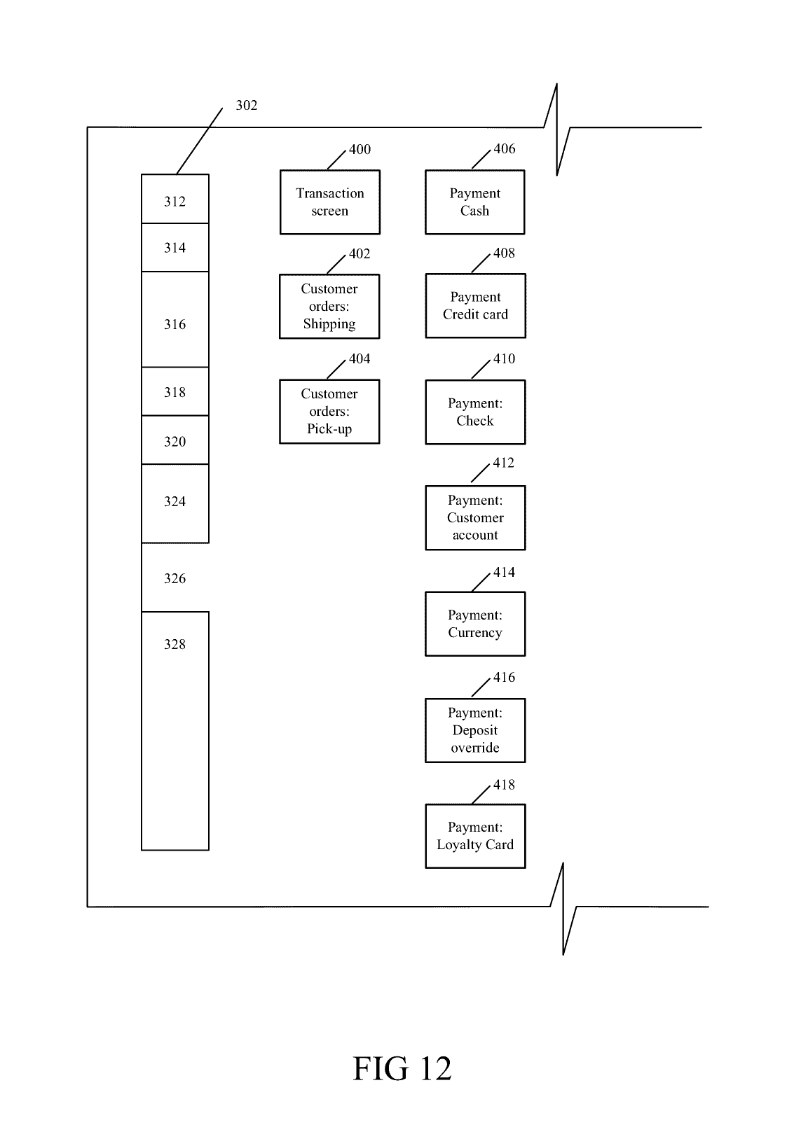

FIG. 12 is a diagrammatic view of a portion of a user interface of a point of sale device in accordance with one embodiment. As shown in FIG. 12, a user has selected cart/shopping bag user interface element 326 from vertical navigation bar 302. Upon selection of element 326, a number of appropriate user interface elements, such as tiles, appear in the main portion of the user interface. Examples of such tiles include transaction screen tile 400, which allows the user to view and/or modify transaction details. The user may also select customer orders (shipping) element 402 in order to enter or modify shipping details for items of the transaction. Additionally, in the event that the customer will be picking up the items of the transaction from the store, the user can select tile 404 to arrange for pick up details. A number of payment options are also available in order to support the transaction. As shown in FIG. 12, examples of such payment options include cash tile 406, credit card tile 408, check tile 410, customer account tile 412, as well as any other suitable payment options, such as gift cards, et cetera. Additionally, tile 414 is provided to allow the user to change the currency in which payment is made. For example, if the user is paying in currency from a different country, the user can easily change the transaction to the customer's currency using tile 414. Additionally, tile 416 is provided to allow the user to create a deposit override if required. Finally, loyalty information can be entered and potentially used to support the transaction using tile 418. As can be appreciated, any suitable tiles that are useful to the user in supporting the transaction of the customer can be provided on the user interface. Additionally, in accordance with embodiments described herein, various interactions between the user and the point of sale application can be captured and stored such that machine learning component 222 (shown in FIG. 3) can also improve efficiencies of the user interface thereby placing certain items of the user interface.

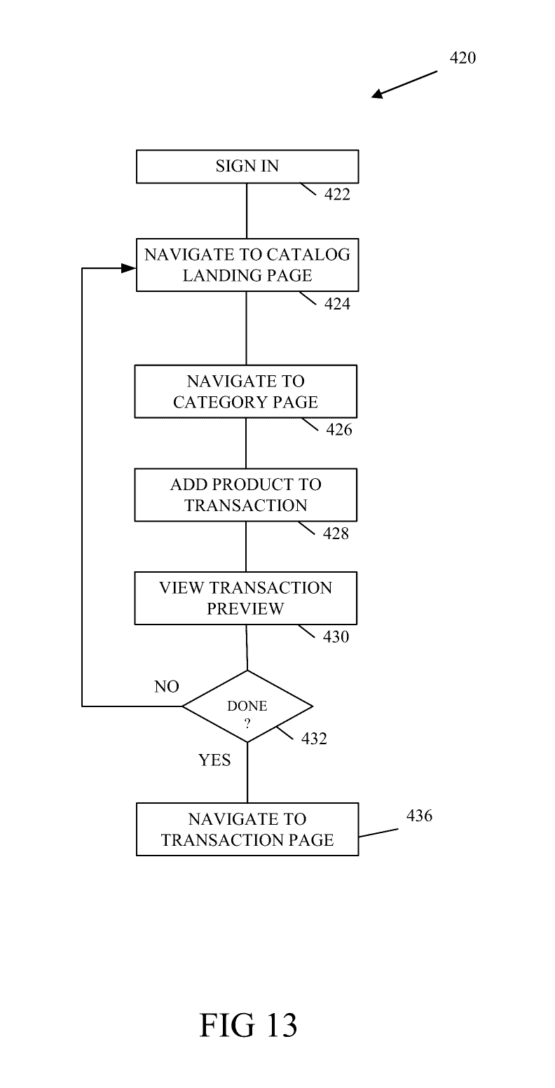

FIG. 13 is a flow diagram of a method of supporting a transaction using a point of sale device in accordance with an embodiment. Method 420 beings at block 422 where a user of the point of sale device signs in to the point of sale device. An example of this sign in process is provided above with respect to FIGS. 5A and 5B. Upon successfully signing in, the point of sale application displays an initial catalog landing page, as indicated at block 424. Upon viewing the initial category landing page, the user will typically navigate to a category page, as indicated at block 426. Once a suitable product has been located via the navigation within the catalog and category pages, one or more products may be added to a particular transaction, as indicated at block 428. Next, at block 430, the transaction can be previewed by the user. This can provide a useful point in order for the user to ask the customer whether they are aware of certain promotions that may be related to one or more of the line items of the transaction. Next, at block 432, method 420 determines whether the transaction is complete. If the transaction is not complete control returns to block 424 via line 434. If the transaction is complete, method 420 continues to block 436 where the transaction page is shown to the user in order to complete the transaction, such as by entering payment information, shipping information, etc.

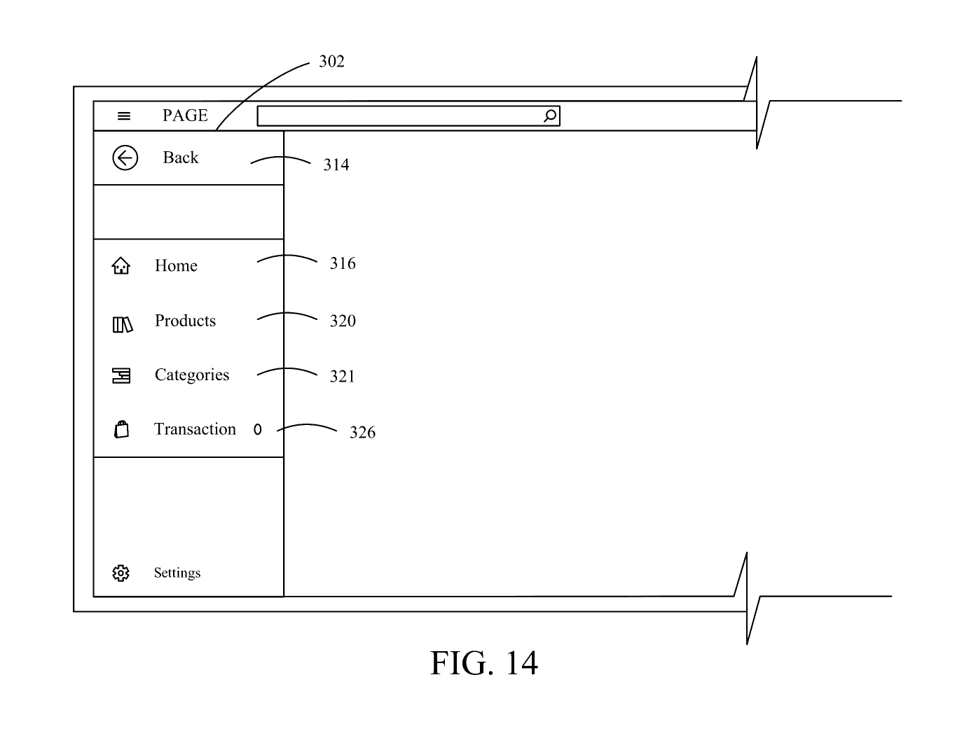

FIG. 14 is a diagrammatic view of a portion of a user interface of a point of sale device in accordance with one embodiment. FIG. 14 illustrates that vertical navigation bar 302 may, in some embodiments, be wider and have more descriptive labels. For example, on devices that have substantially larger displays (tablet vs. smartphone) the vertical navigation bar may appear as shown in FIG. 14. Navigation bar 302 includes contextual back button 314 as well as home button 316 and products or catalog button 320. Additionally, categories button 321 is also provided to allow the user to interact directly with product categories. Finally, transaction button 326 is also provided. As shown in FIG. 14, the cart count is shown to the right of the transaction button, or embedded therein. This is useful on wider vertical navigation bars, such as that shown in FIG. 14. However, it is also contemplated that the cart count indicator could be disposed below transaction button 326.

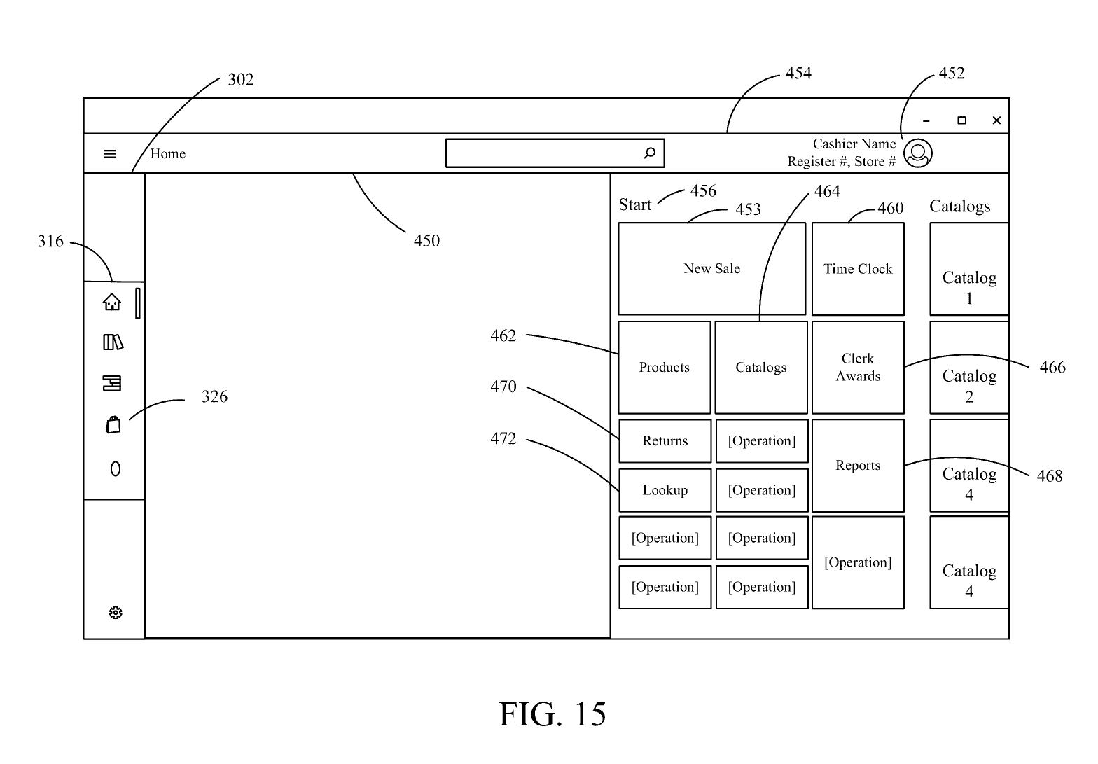

FIG. 15 is a diagrammatic view of a user interface of a point of sale device where the user has selected home button 316. Upon selection of home button 316, the right portion of the user interface shows a home screen. In the example shown in FIG. 15, the home screen may include promotions region 450 providing a relatively constant reminder to the user of current promotions that are being provided by the store. Additionally, vertical navigation bar 302 continues to be shown in the leftmost portion of the user interface allowing the user to quickly navigate between different aspects of the point of sale application. FIG. 15 also indicates that the user has logged in as “Cashier Name” as indicated by identity portion 452. Further, the user interface indicate the particular register and store into which the user has logged. This is particularly useful in the event that another user should walk up to a point of sale device that has already had a user log in. Home screen 454 also has a start region 456 that has a number of tiles or user interface elements that are grouped because they are generally useful as the start of an operation or workflow. For example, start region 456 includes new sale element 458 which, upon actuation by the user, will begin a new transaction. Additionally, start region 456 also includes timeclock element 460 that allows the user to interact with the timeclock to ensure that the hours worked are properly recorded. Additionally, start portion 456 also includes products element 462 and catalogs element 464. These elements allow the user to directly interact with the products portion of a catalog as well as the catalogs themselves. In the example shown in FIG. 15, a clerk awards element 466 is also provided that allows the user to view their status relative to one or more performance metrics and awards that may be available to clerks or users of the point of sale devices. Further still, depending on the role of the user (such a supervisor) reports tile 468 may be shown. Upon actuation of reports tile 468, the user is brought to a page or display that allows one or more reports to be selected. Reports tile 468 may not be provided for all users (such as cashiers) depending on the role of the user. Start portion 456 also includes return element 470 that allows the user to initiate a new return when a customer returns a product. Further still, look up portion 472 allows the user to simply look up one or more products for which a customer may have a question or require assistance. As shown, any suitable additional tiles or user interface elements can be provided in start portion 456, as appropriate. Home screen 454 also includes catalogs portion 480 that lists one or more individual catalogs that are applicable to the retail enterprise. These catalogs may be applicable to an entire product line of the retail enterprise or a subset thereof. Further, a particular catalog may be limited to products available at a particular store, such as the current store. Finally, a catalog may be limited simply to products that are available in a given promotion or seasonal offering.

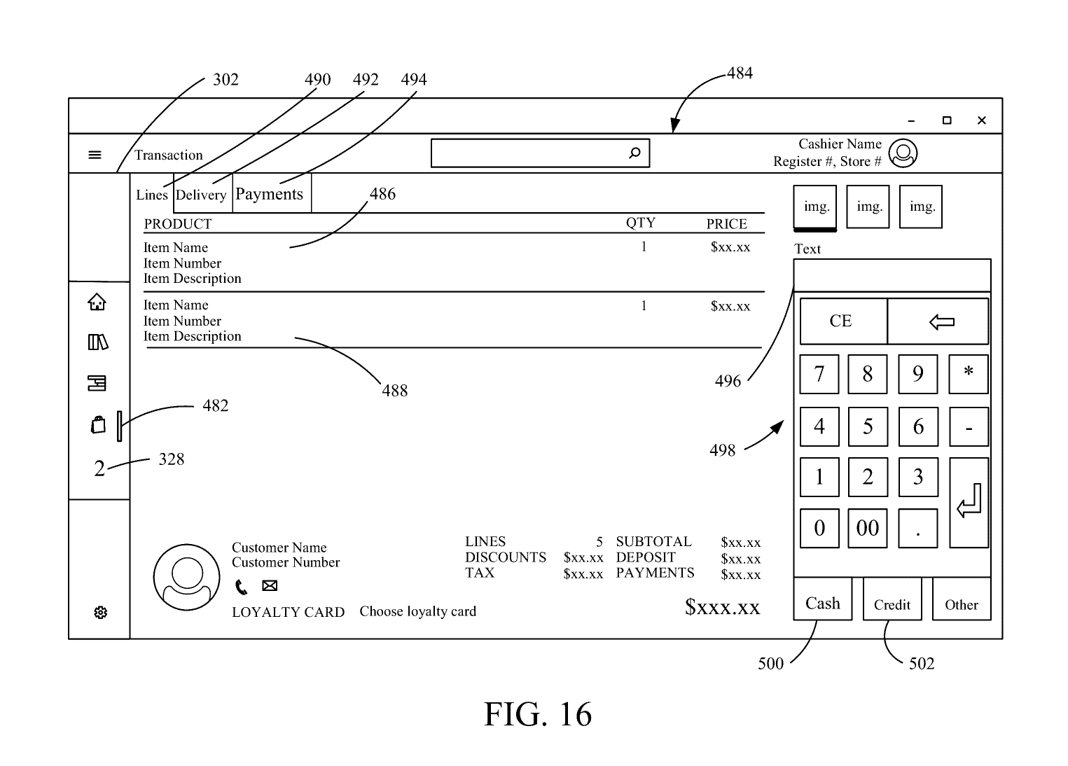

If a user of the user interface displayed in FIG. 15 selects the transaction element 326, the user interface will change to a transaction-centric display, as shown in FIG. 16. Additionally, as shown in FIG. 16, indicator 482 will move proximate the shopping bag indicating that the current display is indicative of a transaction display. Contrasting the positon of indicator 482 with that of FIG. 15, it can be seen that indicator 482 provides an important visual cue showing the user what type of user interface is currently being shown. When transaction page 484 is shown, all of the line items of the current transaction are displayed. Additionally, as shown in FIG. 16, shopping count indicator 328 shows two items. Accordingly, two line items 486, 488 are displayed. In one example, transaction support page 484 has multiple tabs as indicated at lines tab 490, delivery tab 492, and payments tab 494. In the example shown in FIG. 16, lines tab 490 is selected thereby displaying line items 486 and 488. Each line item may be modified by selecting that line item and either entering a product or customer number in field 496 or revising the quantity or price using numeric keypad 498. Once the line items have been modified, and/or are acceptable, the transaction can be completed by setting delivery options, if applicable, using tab 492 and receiving payments via tab 494. As shown in FIG. 16, a number of user interface elements, such as cash button 500 and card button 502 are available in order to facilitate the use of a cash or credit card, respectively, for payment to complete the transaction.

In accordance with various embodiments set forth above, it can be seen that a significant infrastructure can be leveraged in order to accommodate evolving catalogs and modified category hierarchies that can be published easily to various channels using a point of sale application. This ensures that the contents of the catalog and hierarchies are relatively current, accurate and relevant for the user of the point of sale device and the customer. Further, with access to shared channel and catalog information, the point of sale application can surface products and promotions available in other stores, all presented and organized in an improved format. Business operation can be aligned with cashier accounts and role permissions defined in a headquarters application or retail server, as appropriate, in order to provide a collection of workflows tailored to an active user of a point of sale device. These workflows are then surfaced through the user interface of the point of sale device for a given user, and further highlighted when the proper scenario dictates the need or opportunity. Further still, as set forth above, machine learning can provide valuable insights and processing of information in the retail enterprise. Specifically, machine learning can be applied to transaction journals, analyzing customer purchase trends, and leveraging broad cross-channel ecosystems in place to provide insights to users of the point of sale devices that highlight product recommendations, improve and influence sales techniques, or otherwise personalize both the user and the customer experience.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

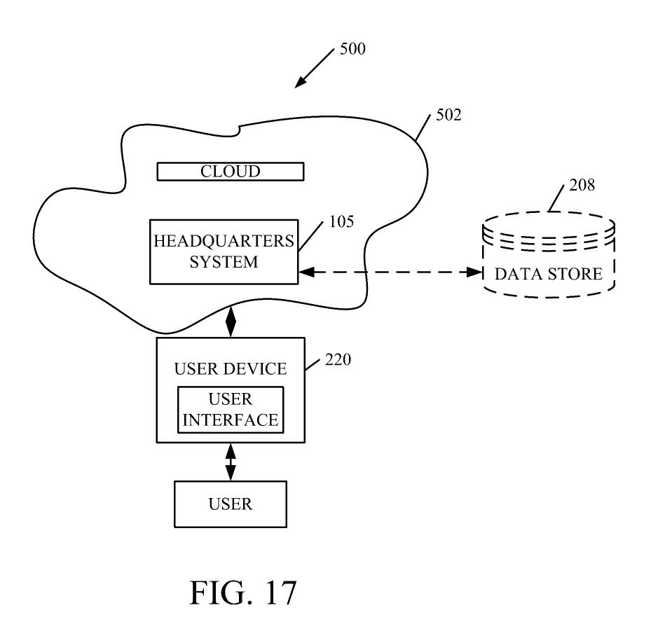

FIG. 17 is a block diagram of an architecture, shown in FIG. 3, except that some elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 105 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 17, headquarters system 105 is located in cloud 502 (which can be public, private, or a combination where portions are public while others are private). Therefore, the user of user device 220 accesses that system through cloud 502. Additionally, or alternatively, any of the store servers 106, 108 and 110, or portions thereof could be deployed in cloud 502.

FIG. 17 also depicts another embodiment of a cloud architecture. FIG. 17 shows that it is also contemplated that some elements of headquarters system 105 are disposed in cloud 502 while others are not. By way of example, data store 208 can be disposed outside of cloud 502, and accessed through cloud 502. Regardless of where they are located, they can be accessed directly, through a network (either a wide area network or a local area network), they can be hosted at a remote site by a service, or they can be provided as a service through a cloud or accessed by a connection service that resides in the cloud. All of these architectures are contemplated herein.

It will also be noted that headquarters system 106, retail servers 106, 108, and 110 as well as any of point of sale devices 112, can be deployed on a wide variety of different devices. Some of those devices include servers, desktop computers, laptop computers, tablet computers, or other mobile devices, such as palm top computers, cell phones, smart phones, multimedia players, personal digital assistants, etc.

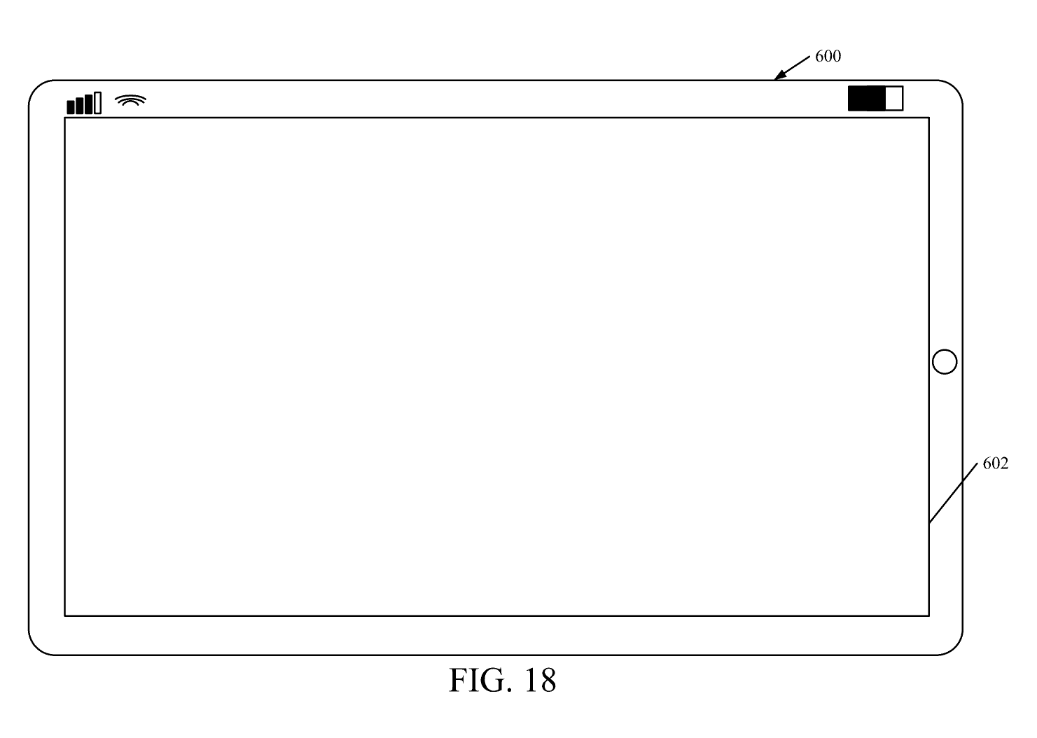

FIG. 18 shows one embodiment in which the point of sale device is a tablet computer 600. In FIG. 18, computer 600 is shown with display screen 602, which can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

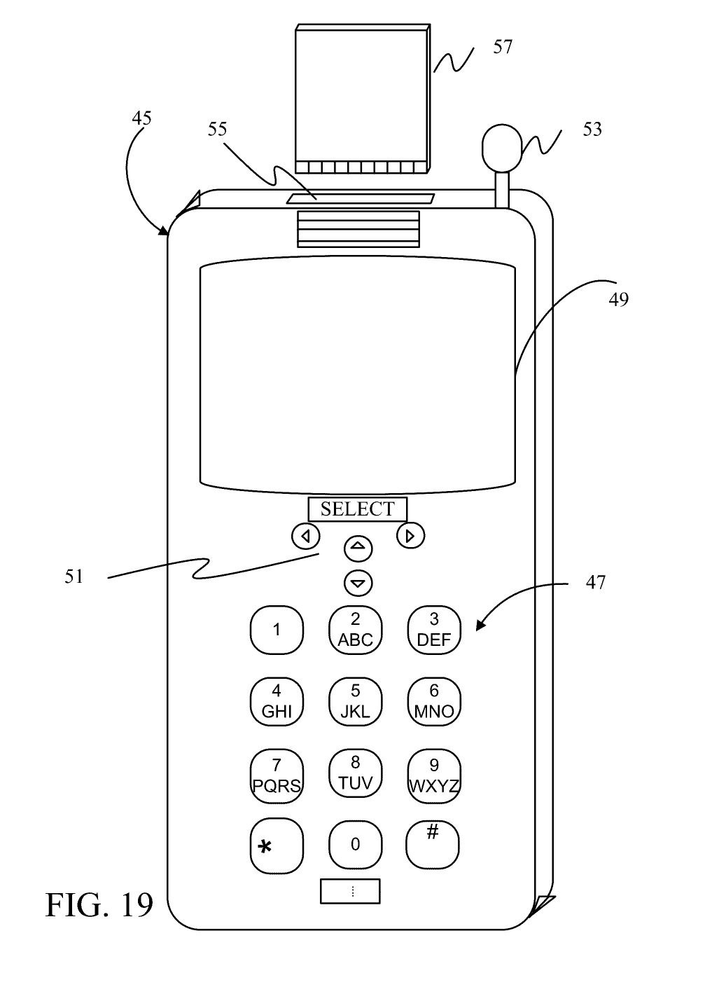

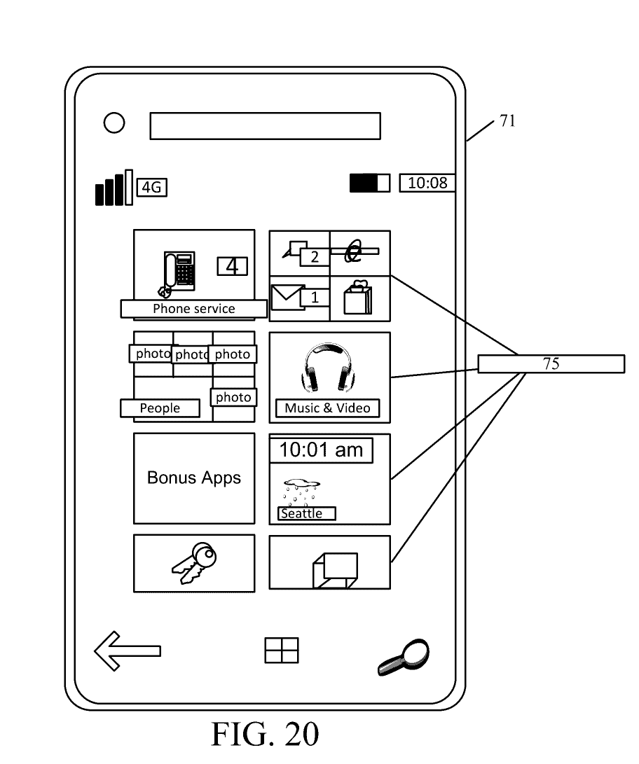

FIGS. 19 and 20 provide additional examples of mobile device that can be point of sale device in accordance with embodiments described herein. In FIG. 19, a feature phone or mobile phone 45 is provided as the point of sale device. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

FIG. 20 is similar to FIG. 19 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of mobile devices 16 are usable as point of sale devices.

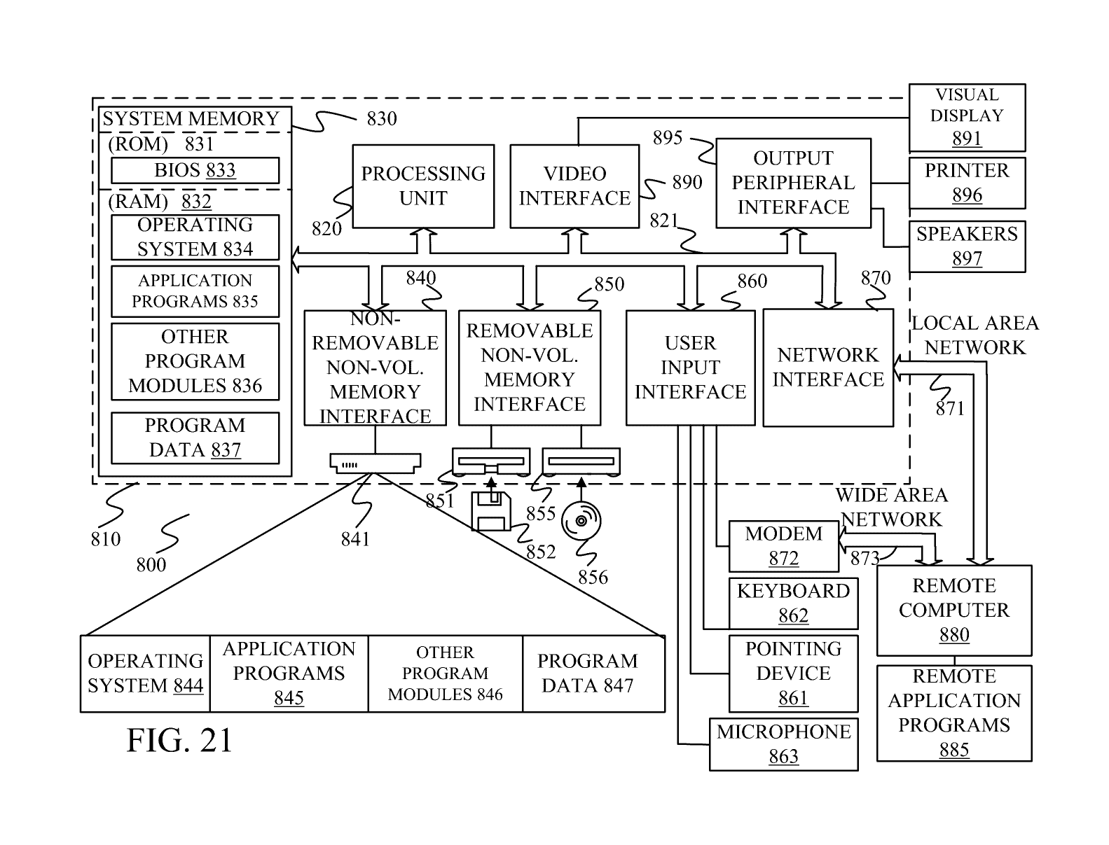

FIG. 21 is one embodiment of a computing environment in which headquarters system 105 or a retail server, or portions thereof, (for example) can be deployed. With reference to FIG. 21, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 21 illustrates operating system 834, application programs 835, other program modules 836, and program data 837.

The computer 810 may also include other removable/non-removable volatile/nonvolatile computer storage media. By way of example only, FIG. 21 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 21, provide storage of computer readable instructions, data structures, program modules and other data for the computer 810. In FIG. 21, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, bar-code reader, credit card scanner, rfid reader, camera, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 21 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computer system for supporting a plurality of locations that each generate sales transactions. The computer system includes a processor and a user interface component coupled to the processor. A configuration component is coupled to the user interface component and is configured to allow a user to configure at least one rule that affects a user interface of a point of sale device with respect to at least one location and to store the configuration information.

Example 2 is the computer system of any or all previous examples wherein the rule includes specification of a visual profile relative to a type of point of sale device.

Example 3 is the computer system of any or all previous examples wherein the at least one rule includes specification of a visual profile relative to a user of the point of sale device.

Example 4 is the computer system of any or all previous examples wherein the at least one rule includes specification of a visual profile relative to the point of sale device.

Example 5 is the computer system of any or all previous examples wherein the at least one rule includes specification of a visual profile relative to one of the plurality of locations.

Example 6 is the computer system of any or all previous examples wherein the at least one rule specifies a permission of a user of the point of sale device.

Example 7 is the computer system of any or all previous examples and further comprising a machine learning component communicatively coupled to receive transaction information and to process the transaction information to generate at least one insight.

Example 8 is the computer system of any or all previous examples wherein the at least one insight is stored in a data store and is configured to be surfaced on at least one point of sale device based on a context of the point of sale device.

Example 9 is the computer system of any or all previous examples wherein the context is indicative of a purchase of a first product and wherein the insight includes a suggestion for a second product.

Example 10 is a computer system for facilitating a transaction. The computer system includes a processor and a display operably coupled to the processor and configured to display a user interface to a user. A user interface component is coupled to the processor and is configured to provide at least one user interface element based on a context.

Example 11 is the computer system of any or all previous examples wherein the user interface element is indicative of an insight and wherein the context is based on a current transaction.

Example 12 is the computer system of any or all previous examples wherein the at least one user interface element is based on a context of the computer system.

Example 13 is a computer system for supporting a plurality of locations that each generate sales transactions. The computer system includes a processor and a communication component coupled to the processor and configured to communicate with at least one remote device. A machine learning component is coupled to the communication component to receive retail transaction information and to generate at least one insight based on the retail transaction information.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system for supporting a plurality of locations that each generate sales transactions, the computer system comprising:
a processor;
a user interface component coupled to the processor; and
a configuration component coupled to the user interface component and configured to allow a user to configure at least one aspect of a user interface that is provided on a point of sale device with respect to at least one location and to store the configuration information.

2. The computer system of claim 1, wherein the at least one aspect defining a role information for a retail enterprise.

3. The computer system of claim 2, wherein the role is a supervisor role, and wherein at least one permission is set relative to a business operation based on the role.

4. The computer system of claim 2, wherein the configuration component allows a user to assign a person to a defined role.

5. The computer system of claim 1, wherein the at least one aspect includes a definition of at least one rule relative to a retail enterprise.

6. The computer system of claim 4, wherein the rule includes specification of a visual profile relative to a type of point of sale device.

7. The computer system of claim 4, wherein the rule includes specification of a visual profile relative to a user of a point of sale device.

8. The computer system of claim 4, wherein the rule includes specification of a visual profile relative to a particular point of sale device.

9. The computer system of claim 1, and further comprising a data store containing structured catalog information.

10. The computer system of claim 1, and further comprising a machine learning component communicatively coupled to receive transaction information and to process the transaction information to generate at least one insight.

11. The computer system of claim 10, wherein the at least one insight is stored in the data store and is configured to be surfaced on at least one point of sale device based on a context of the point of sale device.

12. The computer system of claim 11, wherein the context is indicative of a purchase of a first product and wherein the insight includes a suggestion for a second product.

13. A computer system for facilitating a transaction, the computer system comprising:
a processor;
a display operably coupled to the processor and configured to display a user interface to a user;
a user interface component coupled to the processor and configured to selectably provide a navigation element on the display based on a context.

14. The computer system of claim 13, wherein the navigation element is a navigation bar that is selectably engageable based on a user input.

15. The computer system of claim 14, wherein the user input includes a directional swipe of a user's finger on the display of the computer system.

16. The computer system of claim 14, wherein the navigation bar is a vertical navigation bar located on a left edge of the display, and wherein the vertical navigation bar includes at least one contextual element.

17. The computer system of claim 16, wherein the at least one contextual element is an element that, when actuated by the user, returns the user to a previous operation.

18. The computer system of claim 16, wherein the at least one contextual element is a refiner.

19. The computer system of claim 13, wherein the computer system is embodied on a mobile device.

20. A computer system for supporting a plurality of locations that each generate sales transactions, the computer system comprising:
a processor;
a communication component coupled to the processor and configured to communicate with at least one remote device; and
a machine learning component coupled to the communication component to receive retail transaction information and to generate at least one insight based on the retail transaction information.
